(19) United States
(12) Patent Application Publication
(10) Pub. No.: US 2024/0357603 A1
(43) Pub. Date: Oct. 24, 2024

(54) COMMON SPATIAL FILTER INDICATION FOR CORESETS IN MULTI-TRANSMISSION RECEPTION POINT SYSTEMS

(71) Applicant: Telefonaktiebolaget LM Ericsson (publ), Stockholm (SE)

(72) Inventors: Siva MURUGANATHAN, Stittsville (CA); Andreas NILSSON, Göteborg (SE); Shiwei GAO, Nepean (CA)

(21) Appl. No.: 18/687,613

(22) PCT Filed: Aug. 30, 2022
(86) PCT No.: PCT/IB2022/058119

§ 371 Date: Feb. 28, 2024

Related U.S. Application Data
(60) Provisional application No. 63/238,282, filed on Aug. 30, 2021.

(51) Int. Cl. H04W 72/23; H04L 5/00

(52) U.S. Cl. CPC H04W 72/23; H04L 5/0053; H04L 5/0094

(57) ABSTRACT

A method, network node and wireless device (WD) for common spatial filter indications for control resource sets (CORSETs) in multiple transmission reception point (TRP) systems are disclosed. According to one aspect, a method in a network node includes activating a plurality of transmission configuration indication (TCI) states. The method also includes configuring a beam index information element (IE) to associate a CORESET to at least one of the unified TCI states.

### TECHNICAL FIELD

The present disclosure relates to wireless communications, and in particular, to common spatial filter indication for control resource sets (CORSETs) in multiple transmission reception point (TRP) systems.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

In New Radio (NR), several signals can be transmitted from different antenna ports at the same base station. These signals can have the same large-scale properties such as Doppler shift and Doppler spread, average delay spread, or average delay. These antenna ports are then said to be quasi co-located (QCL).

If the WD knows that two antenna ports are QCL with respect to a certain parameter (e.g., Doppler spread), the WD can estimate that parameter based at least in part on one of the antenna ports and apply that estimate for receiving signal on the other antenna port.

For example, there may be a QCL relation between a channel state information reference signal (CSI-RS) for tracking reference signal (TRS) and the PDSCH demodulation reference signal (DMRS). When the WD receives the PDSCH DMRS, it can use the measurements already made on the TRS to assist the DMRS reception.

Information about what assumptions can be made regarding QCL is signaled to the WD from the network. In NR, four types of QCL relations between a transmitted source RS and transmitted target RS were defined:

Type A: {Doppler shift, Doppler spread, average delay, delay spread};
Type B: {Doppler shift, Doppler spread};
Type C: {average delay, Doppler shift}; and
Type D: {Spatial receive (RX) parameter}.

QCL type D was introduced to facilitate beam management with analog beamforming and is known as spatial QCL. There is currently no strict definition of spatial QCL, but one understanding is that if two transmitted antenna ports are spatially QCL, the WD can use the same Rx beam to receive them. This is helpful for a WD that uses analog beamforming to receive signals, since the WD needs to adjust its receive (RX) beam in some direction prior to receiving a certain signal. If the WD knows that a first signal received earlier is spatially QCL with a second signal received subsequent to the first signal, then it can safely use the same RX beam to receive the second signal. Note that for beam management, QCL Type D, is considered, but it is also necessary to convey a Type A QCL relation for the reference signals to the WD, so that the base station (network node) can estimate all the relevant large-scale parameters.

Typically, this is achieved by configuring the WD with a CSI-RS for tracking (TRS) used for time and frequency offset estimation. To be able to use any QCL reference, the WD would have to receive it with a sufficiently good signal to interference plus noise ratio (SINR), i.e., SINR above a threshold. In many cases, this means that the TRS must be transmitted in a suitable beam to a certain WD.

To introduce dynamics in beam and transmission reception point (TRP) selection, the WD can be configured through radio resource control (RRC) signaling with up to 128 TCI (Transmission Configuration Indicator) states. The TCI state information element is as follows:

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI state contains QCL information related to one or two reference signals (RSs). For example, a TCI state may contain CSI-RS1 associated with QCL Type A and CSI-RS2 associated with QCL TypeD. If a third RS, e.g., the PDCCH DMRS, has this TCI state as QCL source, then the WD can derive Doppler shift, Doppler spread, average delay, delay spread from CSI-RS1 and Spatial RX parameter (i.e., the RX beam to use) from CSI-RS2 when performing channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via medium access control (MAC) control element (CE) one TCI state for PDCCH and up to eight TCI states for PDSCH. The number of active TCI states the WD supports is a WD capability, but the maximum is 8.

Assume a WD has 4 activated TCI states (from a list of 64 configured TCI states). Hence, 60 TCI states are inactive for this particular WD and the WD need not be prepared to have large scale parameters estimated for those inactive TCI states. But the WD continuously tracks and updates the large scale parameters for the RSs in the 4 active TCI states. When scheduling a PDSCH to a WD, the downlink control information (DCI) contains a pointer to one activated TCI state. The WD then knows which large scale parameter estimate to use when performing PDSCH DMRS channel estimation and thus PDSCH demodulation.

As long as the WD can use any of the currently activated TCI states, it is sufficient to use DCI signaling. However, at some point in time, none of the source RSs in the currently activated TCI states can be received by the WD, i.e., when the WD moves out of the beams in which the source RSs in the activated TCI states are transmitted. When this happens (or actually before this happens), the network node would have to activate new TCI states. Typically, since the number of activated TCI states is fixed, the network node would also have to deactivate one or more of the currently activated TCI states.

The two-step procedure related to TCI state update is depicted in FIG. 1.

### TCI States Activation/Deactivation for WD-Specific PDSCH Via MAC CE

The structure of the MAC CE for activating/deactivating TCI states for WD specific PDSCH is given in FIG. 2

As shown in FIG. 2, the MAC CE contains the following fields:
Serving Cell ID: This field indicates the identity of the Serving Cell for which the MAC CE applies. The length of the field is 5 bits;
Bandwidth part (BWP) ID: This field contains the ID corresponding to a downlink bandwidth part for which the MAC CE applies. The BWP ID is given by the higher layer parameter BWP-Id as specified in the 3GPP Technical Standard (TS) 38.331. The length of the BWP ID field is 2 bits since a WD can be configured with up to 4 BWPs for the downlink (DL);
A variable number of fields Ti: If the WD is configured with a TCI state with TCI State ID i, then the field Ti indicates the activation/deactivation status of the TCI state with TCI State ID i. If the WD is not configured with a TCI state with TCI State ID i, the MAC entity ignores the Ti field. The Ti field is set to “1” to indicate that the TCI state with TCI State ID i is activated and mapped to a codepoint of the DCI Transmission Configuration Indication field, as specified in the 3GPP TS 38.214/38.321. The Ti field is set to “0” to indicate that the TCI state with TCI State ID i is to be deactivated and is not mapped to any codepoint of the DCI Transmission Configuration Indication field. It should be noted that the codepoint to which the TCI State is mapped is determined by the ordinal position among all the TCI States with Ti field set to “1”. That is, the first TCI State with Ti field set to “1” is mapped to the codepoint value 0 of DCI Transmission Configuration Indication field, the second TCI State with Ti field set to “1” is mapped to the codepoint value 1 of DCI Transmission Configuration Indication field, and so on. In 3GPP NR Technical Release 15 (3GPP NR Rel-15), the maximum number of activated TCI states is 8; and
A Reserved bit R: this bit is set to ‘0’ in 3GPP NR Rel-15.

Note that the TCI States Activation/Deactivation for WD-specific PDSCH MAC CE are identified by a MAC protocol data unit (PDU) subheader with logical channel ID (LCID) as specified in Table 6.2.1-1 of the 3GPP TS 38.321. The MAC CE for Activation/Deactivation of TCI States for WD-specific PDSCH has variable size.

### TCI State Indication for WD-Specific PDSCH Via DCI

The network node can use DCI format 1_1 or 1_2 to indicate to the WD that should use one of the activated TCI states for the subsequent PDSCH reception. The field being used in the DCI is a transmission configuration indication (TCI), which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 3.

DCI code point 0 indicates the first TCI state index in the list of TCI states, DCI code point 1 indicates the second TCI state index in the list, and so on.

### Multi-TRP TCI State Operation

In 3GPP Release 16 (3GPP Rel-16), a multi-TRP (multiple-transmission reception point) operation was specified and it has two modes of operation, single DCI based multi-TRP and multiple DCI based multi-TRP.

In 3GPP NR Rel-16, multiple DCI scheduling is for multi-TRP in which a WD may receive two DCIs each scheduling a PDSCH and PUSCH. The two DCIs (carried by respective PDCCHs which schedule respective PDSCHs) are transmitted from the same TRP.

For multi-DCI multi-TRP operation, a WD needs to be configured with two CORESET pools, each associated with a TRP. Each CORESET pool is a collection of CORESETs that belongs to the same CORESET pool. A CORESET pool index can be configured in each CORESET with a value of 0 or 1. For the two DCIs in the above example, they are transmitted via respective PDCCHs in two CORESETs belonging to different CORESET pools (i.e. with CORESETPoolIndex 0 and 1 respectively). For each CORESET Pool, the same TCI state operation method in terms of activation/deactivation/indication as described above is assumed.

The other multi-TRP mode, single DCI based multi-TRP, needs two DL TCI states to be associated to one DCI codepoint. That is, when a TCI field codepoint in DCI indicates two TCI states, each TCI state corresponding to a different beam or different TRP. The activation and mapping of 2 TCI states for a codepoint in the TCI field of DCI is performed with the below MAC CE from 3GPP TS 38.321:

### Enhanced TCI States Activation/Deactivation for WD-Specific PDSCH MAC CE

The Enhanced TCI States Activation/Deactivation for WD-specific PDSCH MAC CE is identified by a MAC PDU subheader with eLCID, as shown in FIG. 4, and has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in 3GPP TS 38.212. The length of the BWP ID field is 2 bits;
Ci: This field indicates whether the octet containing TCI state IDi,2 is present. If this field is set to “1”, the octet containing TCI state IDi,2 is present. If this field is set to “0”, the octet containing TCI state IDi,2 is not present;
TCI state IDi,j: This field indicates the TCI state identified by TCI-StateId as specified in 3GPP TS 38.331, where i is the index of the codepoint of the DCI Transmission configuration indication field as specified in 3GPP TS 38.212 and TCI state IDi,j denotes the jth TCI state indicated for the ith codepoint in the DCI TCI field. The TCI codepoint to which the TCI States are mapped is determined by its ordinal position among all the TCI codepoints with sets of TCI state IDi,j fields, i.e., the first TCI codepoint with TCI state ID0,1 and TCI state ID0,2 is mapped to the codepoint value 0, the second TCI codepoint with TCI state ID1,1 and TCI state ID1,2 is mapped to the codepoint value 1 and so on. The TCI state IDi,2 is optional based on the indication of the Ci field. The maximum number of activated TCI codepoints is 8 and the maximum number of TCI states mapped to a TCI codepoint is 2; and
R: Reserved bit, set to “0”.

### Inter-Cell Multi-TRP Operation

In 3GPP Rel-17, inter-cell multi-TRP operations are to be specified. This is an extension of either single DCI based multi-TRP or multiple DCI based multi-TRP operation of 3GPP Rel-16. The intercell aspect of 3GPP Rel-17 refers to the case when the two TRPs are associated to different synchronization signal blocks (SSB) associated with different PCIs (Physical Cell IDs). That is, the TCI state that refers to transmission from TRP 1 or TRP 2 is quasi-collocated to a reference signal that is either one of the SSB beams with the PCI belonging to that TRP, or is quasi-collocated to another reference signal like CSI-RS or DMRS that has root quasi-collocation to one of the SSB beams with PCI belonging to that TRP.

### 3GPP Rel-17 TCI State Framework

In 3GPP Rel-17 a new unified TCI state framework will be specified, which aims to streamline the indication of transmit/receive spatial filtering (and other QCL properties) to the WD by letting a single TCI state indicate QCL properties for multiple different DL and/or uplink (UL) signals/channels. To which DL/UL signals/channels that the unified TCI state framework should be applied is still being considered by the 3GPP. See the following statement from RAN1 #104-e:

### Statement

In 3GPP Rel-17, a unified TCI framework, the following has been considered by RAN1 #104bis-e:
Whether DL or, if applicable, joint TCI also applies to the following signals. If not, for future study (FFS) any other enhancement over 3GPP Rel-15/16:
   CSI-RS resources for CSI;
   Some CSI-RS resources for beam management (BM), if so, which ones (e.g., aperiodic, repetition ‘ON’);
   CSI-RS for tracking;
Whether UL or, if applicable, joint TCI also applies to the following signals:
   Some sounding reference signal (SRS) resources or resource sets for BM.

Note that the term ‘joint TCI’ in the above statement, refers to a ‘joint DL/UL TCI state’.

In meeting RAN1 #103-e it was considered that the new unified TCI state framework should include a three stage TCI state indication (in a way that is similar to that described above for PDSCH) for all or a subset of all DL and/or UL channels/signals. In the first stage, radio resource control (RRC) is used to configure a pool of TCI states. In the second stage, one or more of the RRC configured TCI states are activated via MAC-CE signaling and associated to different TCI field codepoints in DCI format 1_1 and 1_2. Finally, in the third stage, DCI signaling is used to select one of the TCI states (or two TCI states in case separate TCI states are used for DL channels/signals and UL channels/signals) that was activated via MAC-CE.

In RAN1 #103-e meeting, there has been consideration of support for both joint beam indication (“Joint DL/UL TCI”) and separate DL/UL beam indication (“Separate DL/UL TCI”), as can be seen in the statements below. For Joint DL/UL TCI, a single TCI state (which for example, can be a DL TCI state or a Joint DL/UL TCI state) is used to determine a transmit/receive spatial filter for both DL signals/channels and UL signals/channels. For Separate DL/UL TCI, one TCI state (for example, a DL TCI state) can be used to indicate a receive spatial filter for DL signals/channels and a separate TCI state (for example, an UL TCI state) can be used to indicate a transmit spatial filter for UL signals/channels.

### Statement

On beam indication signaling medium to support joint or separate DL/UL beam indication in 3GPP Rel-17 unified TCI framework:
Support L1-based beam indication using at least WD-specific (unicast) DCI to indicate joint or separate DL/UL beam indication from the active TCI states:
   The existing DCI formats 1_1 and 1_2 are reused for beam indication;
Support activation of one or more TCI states via MAC CE analogous to 3GPP Rel-15/16.

### Statement

On 3GPP Rel-17 unified TCI framework, to accommodate the case of separate beam indication for UL and DL:
Utilize two separate TCI states, one for DL and one for UL;
For the separate DL TCI:
   The source reference signal(s) in M TCIs provide QCL information at least for WD-dedicated reception on PDSCH and for WD-dedicated reception on all or subset of CORESETs in a component carrier (CC);
For the separate UL TCI:
   The source reference signal(s) in N TCIs provide a reference for determining common UL transmit (TX) spatial filter(s) at least for dynamic-grant/configured-grant based PUSCH, all or a subset of dedicated PUCCH resources in a CC;
   Optionally, the UL TX spatial filter can also apply to all SRS resources in resource set(s) configured for antenna switching/codebook-based/non-codebook-based UL transmissions; and/or
FFS: Whether the UL TCI state is taken from a common/same or separate TCI state pool from DL TCI state.

### Ultra-Reliable Low Latency Communications (URLLC) Reliability for Multi-TRP Operation

In 3GPP NR Rel-16, multi-TRP reliability enhancements where specified for PDSCH by repeating PDSCH transmission (using TDM (time domain multiplexing), FDM (frequency domain multiplexing) or SDM (spatial division multiplexing)) over two different TRPs. In 3GPP NR Rel-17, URLLC reliability enhancements will be extended for PDCCH by using TDM, FDM, SFN transmission from two different TRPs. Two schemes have been considered by the 3GPP Rel-17:
One SFN (single frequency network) scheme where two TCI states are associated to one CORESET. In the SFN scheme, two TRPs corresponding to two TCI states; and
One non-SFN scheme where two PDCCH candidates associated to two different search space sets can be linked together (which is called PDCCH repetition scheme).

The PDCCH candidates can be multiplexed in the time domain or the frequency domain.

In 3GPP NR Rel-17, introduction of PDCCH enhancement with multiple TRPs by repeating a PDCCH from different TRPs, has been considered. The following methods may be supported for PDCCH repetition:
PDCCH repetition without soft combining, where a PDCCH is repeated over two TRPs, the PDCCH is considered successfully decoded if any one repetition is decoded successfully. No soft combining is performed at the WD; and/or
PDCCH repetition with soft combining, similar to 2 above, a PDCCH is repeated over two TRPs, but soft combining is performed before PDCCH decoding.

In the SFN scheme, when the WD is receiving a PDCCH DMRS with a CORESET configured with two TCI states, the WD may perform synchronization and estimation of long term channel properties using the DL RS (e.g., TRS) in both TCI states in parallel. For example, it obtains two channel delay spreads (to be compared to legacy operation where a single channel delay spread is obtained). The WD may then combine these measurements to obtain the channel properties of the SFN channel. For example, it can compute a weighted average of the delay spread. This average is then used as input to the channel estimation algorithm for the PDCCH DMRS. Note that the PDCCH and PDCCH DMRS are transmitted as a SFN while the TRS are not transmitted as a SFN, they are transmitter “per TRP”. So the measurements on the TRS give the WD some information on whether one TRP is dominating over the other, e.g., if the WD is close to one of the TRPs or if the channel towards one of the TRPs is blocked. An algorithm in the WD can then decide to only use estimates from one of the TRS (one TCI state) as the SFN transmission is weak (meaning that even if PDCCH is SFN-transmitted, one TRP dominates).

In current 3GPP Rel-17 considerations, the focus has been mainly on TCI state updates for single TRP. However, how to update TCI states for single-DCI based multi-TRP operation is still an unresolved issue.

In the unified TCI state framework currently being specified in 3GPP Rel-17, the WD may determine a WD RX spatial filter for (at least) all WD-dedicated CORESETs based on the single applied DL TCI state. During multi-TRP operation it is expected that two DL TCI states will be applied simultaneously, and it is an unresolved issue how to associate the CORESET(s) to these two applied DL TCI states.

### SUMMARY

Some embodiments advantageously provide methods, network nodes and wireless devices for common spatial filter indications for control resource sets (CORSETs) in multiple transmission point (TRP) systems.

Some embodiments are in one of the following groups of embodiments:
Embodiments using explicit indication of the association between a CORESET and a common beam (by introducing a new common beam index); and
Embodiments using implicit indication of the association between a CORESET and a common beam (based on for example, a lowest CORESET ID or synchronization signal (SS) set ID).

In some embodiments, a method is provided for associating one or multiple CORESETs to two different applied DL TCI states (or Joint DL/UL TCI States). In some embodiments, the method includes one or more of the following steps:
Step 1: Configuring from the network node to a WD a list of DL TCI states (or joint DL/UL TCI states) via higher layer configuration (RRC configuration) to the WD;
Step 2: Activating a subset of a configured list of DL TCI states (or joint DL/UL TCI states) via MAC CE signaling from the network to the WD, where a codepoint in TCI field in DCI may be mapped to one or more DL TCI states (or joint DL/UL TCI states);
Step 3: Updating N>1 DL TCI states (or joint DL/UL TCI states) to a WD from the network via a DL DCI;
Step 4: Applying the N>1 updated DL TCI states (or joint DL/UL TCI states) to one CORESET or a group or multiple groups of CORESETs; and
Step 5: Using the applied DL TCI states (or joint DL/UL TCI states) to receive PDCCH(s) over the one CORESET or the one group or multiple groups of CORESETs.

According to one aspect, a network node configured to communicate with a WD includes processing circuitry configured to activate and indicate a first and a second unified transmission configuration indicator, TCI, state of a plurality of unified TCI states configured for the WD, the first and second unified TCI states being used for at least one of downlink reception and uplink transmission for a plurality of physical channels by the WD. The processing circuitry is further configured to associate a control resource set, CORESET, to one of the first unified TCI state and the second unified TCI state by at least one of: configuring a pointer for the CORESET, the pointer pointing to at least one of the first unified TCI state and the second unified TCI state; configuring a CORESET group identifier for the CORESET, the CORESET group identifier identifying a CORESET group to which the CORESET belongs; and according to predefined rules known to the WD.

According to this aspect, in some embodiments, the first and the second unified TCI states are activated by a first medium access control, MAC, control element, CE, command, among a plurality of configured unified TCI states. In some embodiments, the first and the second unified TCI states are indicated by a downlink control information, DCI, format, among a plurality of activated unified TCI states. In some embodiments, associating the CORESET to at least one of the first unified TCI state and the second unified TCI state includes receiving one or more downlink physical downlink control channels, PDCCHs, in the CORESET according to the at least one of the first unified TCI state and the second unified TCI state. In some embodiments, the network node further includes a radio interface in communication with the processing circuitry and configured to transmit to the WD in at least one of the first medium access control, MAC, control element, CE command, and the DCI, the pointer and the group identifier. In some embodiments, the first and second unified TCI states contain information of a first and second common beam, respectively. In some embodiments, the first and second common beams are associated to a first and a second transmission and reception point, TRP, respectively. In some embodiments, the first and second unified TCI states contain information of a first and second spatial receive filter, respectively. In some embodiments, when the pointer is not configured for the CORESET, then the CORESET is associated with one of the first and second unified TCI states by default. In some embodiments, the pointer is transmitted in a second medium access control, MAC, control element, CE command. In some embodiments, the group identifier is transmitted in the second MAC CE command. In some embodiments, the second MAC CE command is the same as the first MAC CE command. In some embodiments, the pointer is transmitted in a Radio Resource Control (RRC) message. In some embodiments, the group identifier is transmitted in a radio resource control, RRC, message. In some embodiments, each of a first group of CORESETs is associated with the first unified TCI state and each of a second group of CORESETs is associated with the second unified TCI state. In some embodiments, one of the predefined rules is that every second CORESET is associated with the first unified TCI state and every other second CORESET is associated with the second unified TCI state. In some embodiments, a CORESET with an even numbered ID is associated with the first unified TCI state and a CORESET with an odd numbered ID is associated with the second unified TCI state. In some embodiments, each CORESET in the first group is associated with one of the first and second unified TCI states in a particular order known to the WD.

According to another aspect, a method in a network node configured to communicate with a wireless device, WD, includes activating and indicating a first and a second unified transmission configuration indicator, TCI, state of a plurality of unified TCI states configured for the WD, the first and second unified TCI states being used for at least one of downlink reception and uplink transmission for a plurality of physical channels by the WD. The method also includes associating a control resource set, CORESET, to one of the first unified TCI state and the second unified TCI state by at least one of: configuring a pointer for the CORESET, the pointer pointing to at least one of the first unified TCI state and the second unified TCI state; configuring a CORESET group identifier for the CORESET, the CORESET group identifier identifying a CORESET group to which the CORESET belongs; and according to predefined rules known to the WD.

According to this aspect, in some embodiments, the first and the second unified TCI states are activated by a first medium access control, MAC, control element, CE, command, among a plurality of configured unified TCI states. In some embodiments, the first and the second unified TCI states are indicated by a downlink control information, DCI, format, among a plurality of activated unified TCI states. In some embodiments, associating the CORESET to at least one of the first unified TCI state and the second unified TCI state includes receiving one or more downlink physical downlink control channels, PDCCHs, in the CORESET according to the at least one of the first unified TCI state and the second unified TCI state. In some embodiments, the method further includes transmitting to the WD in at least one of the first medium access control, MAC, control element, CE command, and the DCI, the pointer and the group identifier. In some embodiments, the first and second unified TCI states contain information of a first and second common beam, respectively. In some embodiments, the first and second common beams are associated to a first and a second transmission and reception point, TRP, respectively. In some embodiments, the first and second unified TCI states contain information of a first and second spatial receive filter, respectively. In some embodiments, when the pointer is not configured for the CORESET, then the CORESET is associated with one of the first and second unified TCI states by default. In some embodiments, the pointer is transmitted in a second medium access control, MAC, control element, CE command. In some embodiments, the group identifier is transmitted in the second MAC CE command. In some embodiments, the second MAC CE command is the same as the first MAC CE command. In some embodiments, the pointer is transmitted in a Radio Resource Control (RRC) message. In some embodiments, the group identifier is transmitted in a radio resource control, RRC, message. In some embodiments, each of a first group of CORESETs is associated with the first unified TCI state and each of a second group of CORESETs is associated with the second unified TCI state. In some embodiments, one of the predefined rules is that every second CORESET is associated with the first unified TCI state and every other second CORESET is associated with the second unified TCI state. In some embodiments, a CORESET with an even numbered ID is associated with the first unified TCI state and a CORESET with an odd numbered ID is associated with the second unified TCI state. In some embodiments, each CORESET in the first group is associated with one of the first and second unified TCI states in a particular order known to the WD.

According to yet another aspect, a WD is configured to communicate with a network node. The WD includes a radio interface configured to: receive an indication of a first and a second unified transmission configuration indication, TCI, state of a plurality of unified TCI states, the first and second unified TCI states being associated with at least one of downlink reception and uplink transmission for a plurality of physical channels; receive a pointer to a control resource set, CORESET, the pointer pointing to at least one of the first and second unified TCI states; and receive a CORESET group identifier identifying a CORESET group to which the CORESET belongs. The WD includes processing circuitry in communication with the radio interface and configured to associate the CORESET to one of the first and second unified TCI states.

According to this aspect, in some embodiments, the processing circuitry is further configured to determine a spatial filter for each of at least two unified TCI states. In some embodiments, the processing circuitry is further configured to associate at least a first CORESET to a first common beam and associate at least a second CORESET to a second common beam. In some embodiments, the processing circuitry is further configured to associate a CORESET with a common beam based at least in part on an ID of the CORESET. In some embodiments, a CORESET with an even numbered ID is associated with a first common beam and a CORESET with an odd numbered ID is associated with a second common beam. In some embodiments, CORESETs in a first set of CORESETs are associated with common beams in a particular order.

According to another aspect, a method in a WD configured to communicate with a network node, includes: receiving an indication of a first and a second unified transmission configuration indication, TCI, state of a plurality of unified TCI states, the first and second unified TCI states being associated with a different beam; receiving a pointer to a control resource set, CORESET, the pointer pointing to at least one of the first and second unified TCI states; and receiving a CORESET group identifier identifying a CORESET group to which the CORESET belongs. The method also includes associating the CORESET with a common beam.

According to this aspect, in some embodiments, the method includes determining a spatial filter for each of at least two unified TCI states. In some embodiments, the method includes associating at least a first CORESET to a first common beam and associate at least a second CORESET to a second common beam. In some embodiments, the method includes associating a CORESET with a common beam based at least in part on an ID of the CORESET. In some embodiments, a CORESET with an even numbered ID is associated with a first common beam and a CORESET with an odd numbered ID is associated with a second common beam. In some embodiments, CORESETs in a first set of CORESETs are associated with common beams in a particular order.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a flowchart of an example process for two-stage TCI state updates;

FIG. 2 illustrates TCI states activation/deactivation;

FIG. 3 is an example of DCI indication of a TCI state;

FIG. 4 is an example of enhanced TCI states;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node for common spatial filter indications for control resource sets (CORSETs) in multiple transmission reception point (TRP) systems;

FIG. 12 is a flowchart of an example process in a wireless device for common spatial filter indications for control resource sets (CORSETs) in multiple transmission reception point (TRP) systems;

FIG. 13 is a flowchart of another example process in a network node for common spatial filter indications for control resource sets (CORSETs) in multiple transmission reception point (TRP) systems;

FIG. 14 is a flowchart of another example process in a wireless device for common spatial filter indications for control resource sets (CORSETs) in multiple transmission reception point (TRP) systems;

FIG. 15 is a first example of activated TCI states;

FIG. 16 is second example of activated TCI states;

FIG. 17 is a third example of activated TCI states;

FIG. 18 is a fourth example of activated TCI states;

FIG. 19 is a fifth example of activated TCI states; and

FIG. 20 is an example of a CORESET information element.

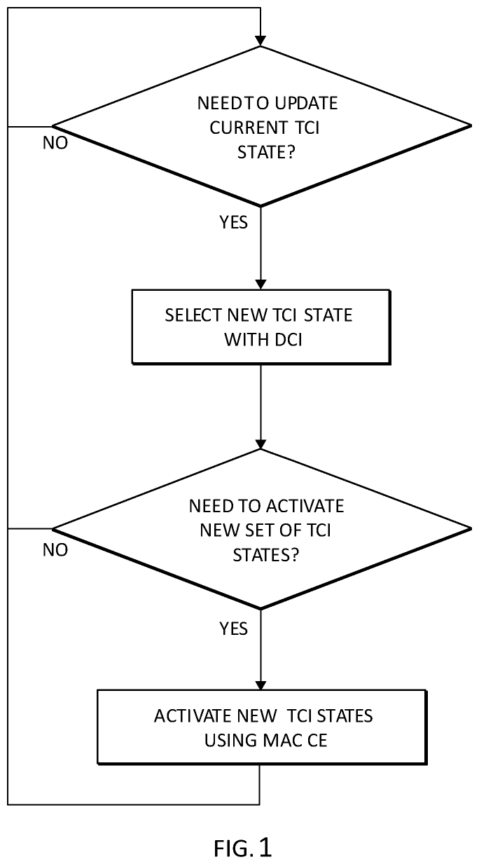

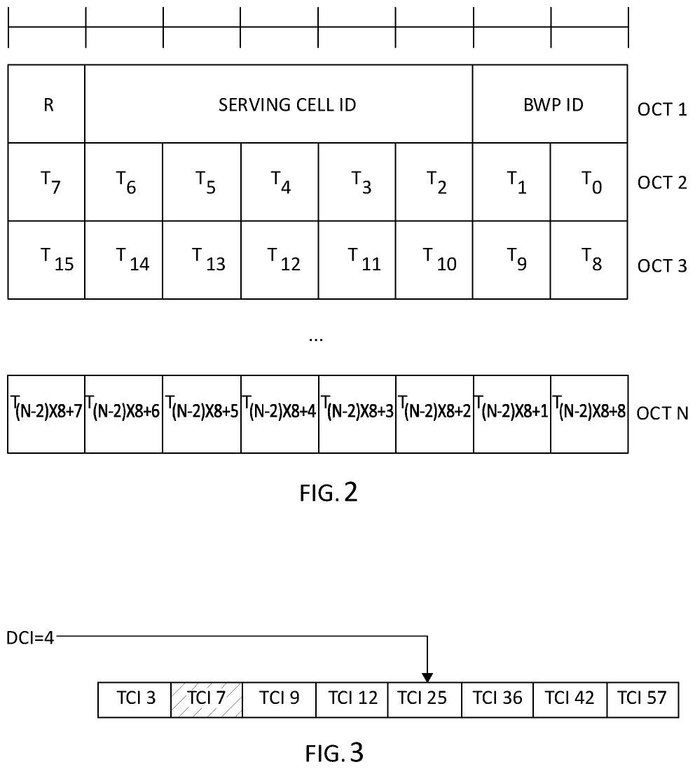

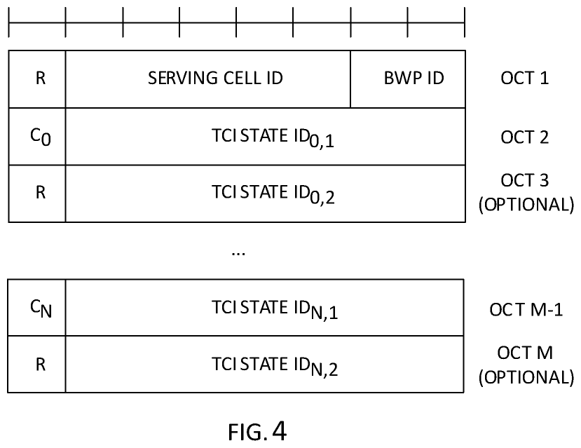

### DETAILED DESCRIPTION

Before describing in detail example embodiments, it is noted that the embodiments reside primarily in combinations of apparatus components and processing steps related to common spatial filter indications for control resource sets (CORSETs) in multiple transmission reception point (TRP) systems. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide common spatial filter indication for control resource sets (CORSETs) in multiple transmission reception point (TRP) systems.

Some embodiments provide a unified TCI framework to support PDCCH reception from multiple TRPs. Some embodiments provide ways to apply the unified TCI framework for multi-TRP scenarios for the purpose of updating common spatial filters for CORESETs.

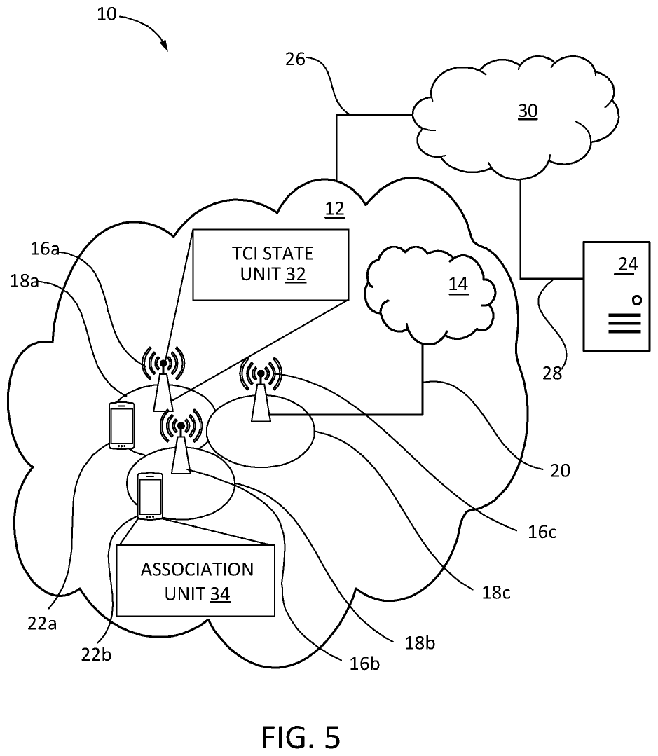

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

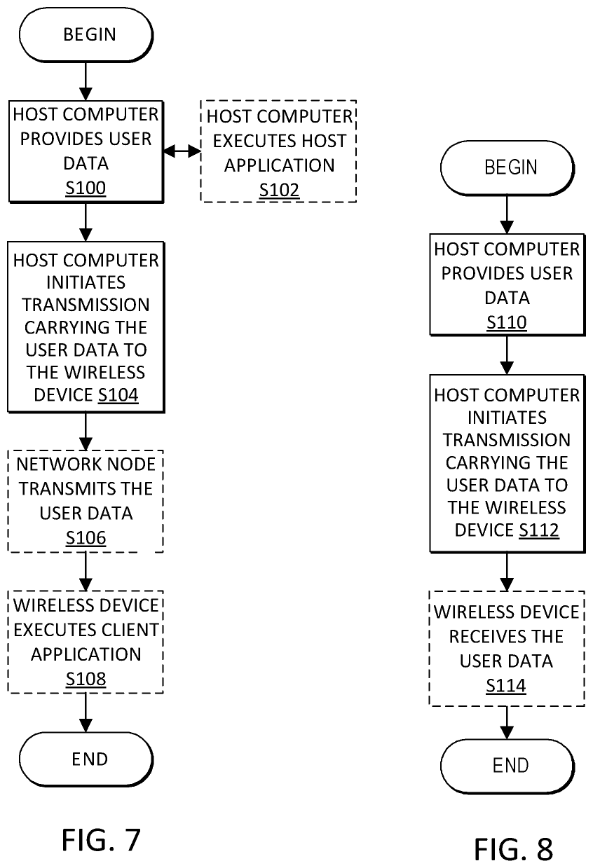

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a TCI state unit 32 which is configured to activate and indicate a first and a second unified transmission configuration indicator, TCI, state of a plurality of unified TCI states configured for the WD. The TCI state unit 32 may also be configured to indicate to the WD at least one transmission configuration indicator, TCI, state, each of the at least one TCI state having quasi-co-located, QCL, information related to at least one reference signal. A wireless device 22 is configured to include an association unit 34 which is configured to associate a CORESET with a common beam. The association unit 34 may also be configured to update spatial filters based on an indicated TCI state.

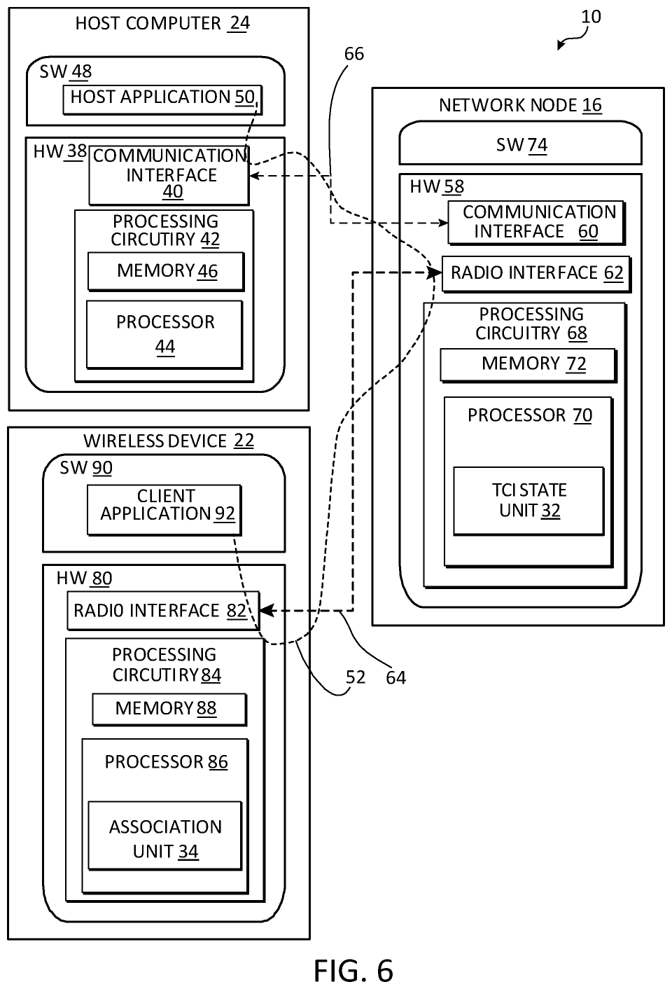

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include TCI state unit 32 which is configured to activate and indicate a first and a second unified transmission configuration indicator, TCI, state of a plurality of unified TCI states configured for the WD. The TCI state unit 32 may also be configured to configure a beam index information element, IE, to associate a control resource set, CORESET, to at least one of the TCI states. The TCI state unit 32 may also be configured to indicate to the WD at least one transmission configuration indicator, TCI, state, each of the at least one TCI state having quasi-co-located, QCL, information related to at least one reference signal.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include association unit 34 which is configured to associate a CORESET with a common beam. The association unit 34 may also be configured to update spatial filters based on an indicated TCI state.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as TCI state unit 32, and association unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

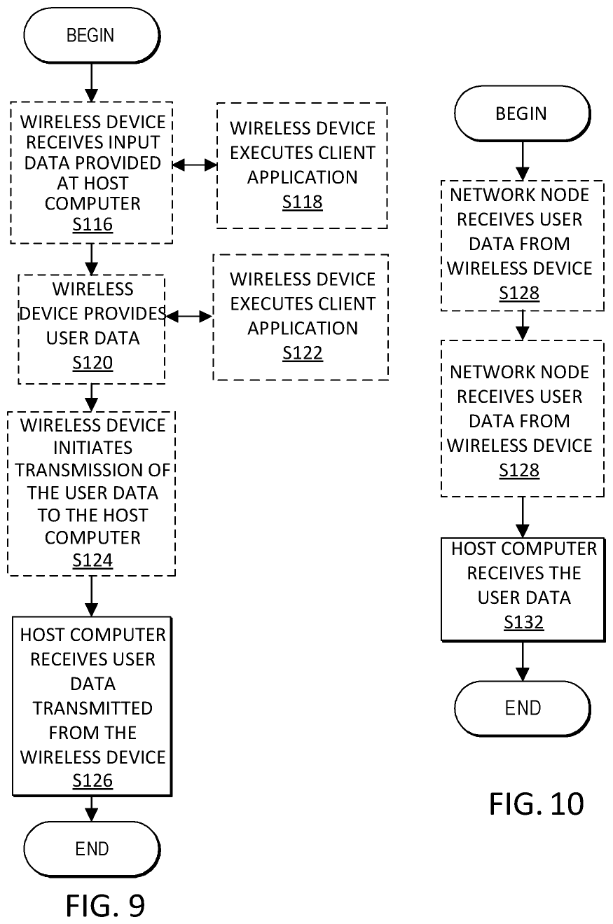

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

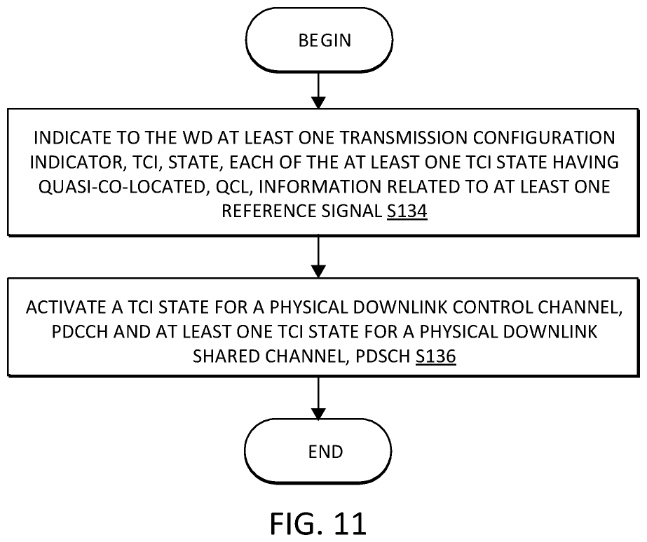

FIG. 11 is a flowchart of an example process in a network node 16 for common spatial filter indications for control resource sets (CORSETs) in multiple transmission point (TRP) systems. One or more blocks described herein may be performed by one or more elements of network node 16 such as by one or more of processing circuitry 68 (including the TCI state unit 32), processor 70, radio interface 62 and/or communication interface 60. Network node 16 is configured to indicate to the WD at least one transmission configuration indicator (TCI) state, each of the at least one TCI state having quasi-co-located (QCL) information related to at least one reference signal (Block S134). The process also includes activating a TCI state for a physical downlink control channel (PDCCH) and at least one TCI state for a physical downlink shared channel (PDSCH) (Block S136).

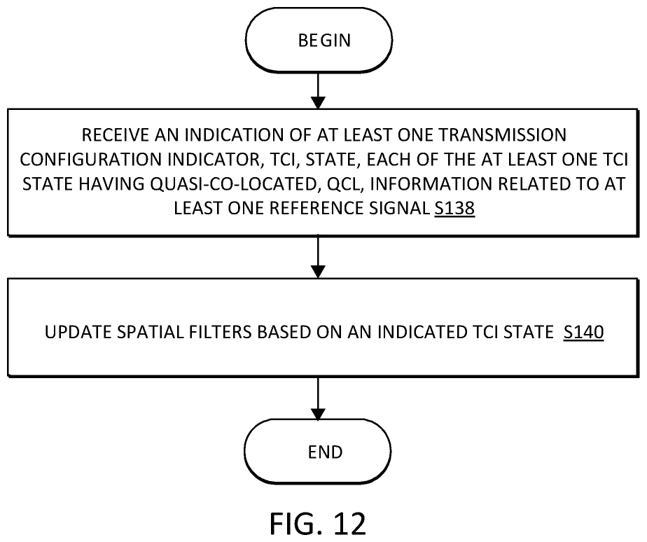

FIG. 12 is a flowchart of an example process in a wireless device 22 according to some embodiments of the present disclosure. One or more blocks described herein may be performed by one or more elements of wireless device 22 such as by one or more of processing circuitry 84 (including the association unit 34), processor 86, radio interface 82 and/or communication interface 60. Wireless device 22 is configured to receive an indication of at least one transmission configuration indicator (TCI) state, each of the at least one TCI state having quasi-co-located (QCL) information related to at least one reference signal (Block S138). The process also includes updating spatial filters based on an indicated TCI state (Block S140).

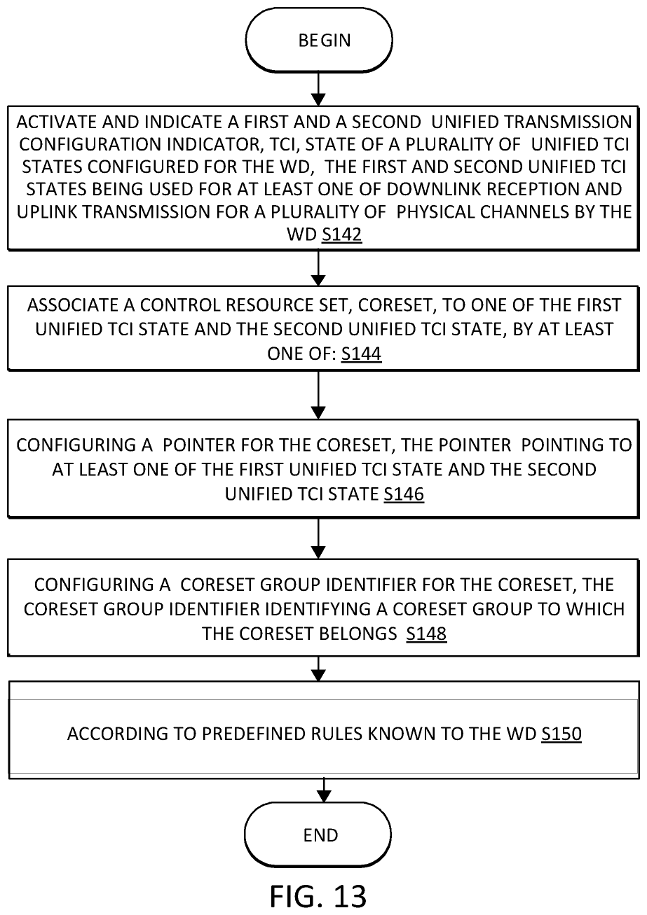

FIG. 13 is a flowchart of an example process in a network node 16 for common spatial filter indications for control resource sets (CORSETs) in multiple transmission point (TRP) systems. One or more blocks described herein may be performed by one or more elements of network node 16 such as by one or more of processing circuitry 68 (including the TCI state unit 32), processor 70, radio interface 62 and/or communication interface 60. Network node 16 is configured to activate and indicate a first and a second unified transmission configuration indicator, TCI, state of a plurality of unified TCI states configured for the WD, the first and second unified TCI states being used for at least one of downlink reception and uplink transmission for a plurality of physical channels by the WD 22 (Block S142). The process also includes associating a control resource set, CORESET, to one of the first unified TCI state and the second unified TCI state by at least one of (Block S144): configuring a pointer for the CORESET, the pointer pointing to at least one of the first unified TCI state and the second unified TCI state (Block S146); configuring a CORESET group identifier for the CORESET, the CORESET group identifier identifying a CORESET group to which the CORESET belongs (Block S148); and according to predefined rules known to the WD 22 (Block S150).

According to this aspect, in some embodiments, the first and the second unified TCI states are activated by a first medium access control, MAC, control element, CE, command, among a plurality of configured unified TCI states. In some embodiments, the first and the second unified TCI states are indicated by a downlink control information, DCI, format, among a plurality of activated unified TCI states. In some embodiments, associating the CORESET to at least one of the first unified TCI state and the second unified TCI state includes receiving one or more downlink physical downlink control channels, PDCCHs, in the CORESET according to the at least one of the first unified TCI state and the second unified TCI state. In some embodiments, the method further includes transmitting to the WD 22 in at least one of the first medium access control, MAC, control element, CE command, and the DCI, the pointer and the group identifier. In some embodiments, the first and second unified TCI states contain information of a first and second common beam, respectively. In some embodiments, the first and second common beams are associated to a first and a second transmission and reception point, TRP, respectively. In some embodiments, the first and second unified TCI states contain information of a first and second spatial receive filter, respectively. In some embodiments, when the pointer is not configured for the CORESET, then the CORESET is associated with one of the first and second unified TCI states by default. In some embodiments, the pointer is transmitted in a second medium access control, MAC, control element, CE command. In some embodiments, the group identifier is transmitted in the second MAC CE command. In some embodiments, the second MAC CE command is the same as the first MAC CE command. In some embodiments, the pointer is transmitted in a Radio Resource Control (RRC) message. In some embodiments, the group identifier is transmitted in a radio resource control, RRC, message. In some embodiments, each of a first group of CORESETs is associated with the first unified TCI state and each of a second group of CORESETs is associated with the second unified TCI state. In some embodiments, one of the predefined rules is that every second CORESET is associated with the first unified TCI state and every other second CORESET is associated with the second unified TCI state. In some embodiments, a CORESET with an even numbered ID is associated with the first unified TCI state and a CORESET with an odd numbered ID is associated with the second unified TCI state. In some embodiments, each CORESET in the first group is associated with one of the first and second unified TCI states in a particular order known to the WD 22.

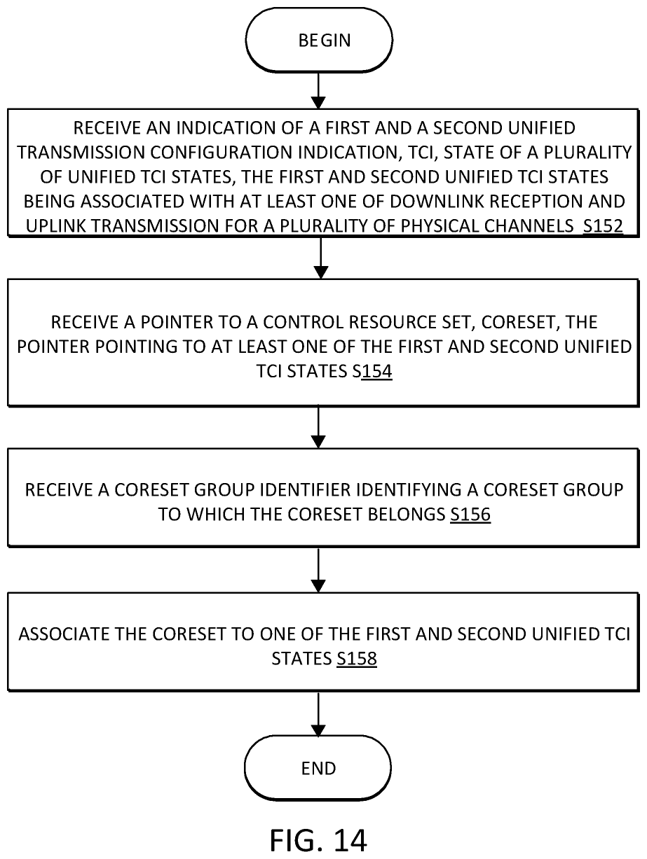

FIG. 14 is a flowchart of an example process in a wireless device 22 according to some embodiments of the present disclosure. One or more blocks described herein may be performed by one or more elements of wireless device 22 such as by one or more of processing circuitry 84 (including the association unit 34), processor 86, radio interface 82 and/or communication interface 60. Wireless device 22 is configured to receive an indication of a first and a second unified transmission configuration indication, TCI, state of a plurality of unified TCI states, the first and second unified TCI states being associated with at least one of downlink reception and uplink transmission for a plurality of physical channels (Block S152); receiving a pointer to a control resource set, CORESET, the pointer pointing to at least one of the first and second unified TCI states (Block S154); and receiving a CORESET group identifier identifying a CORESET group to which the CORESET belongs (Block S156). The method also includes associating the CORESET to one of the first and second unified TCI states (Block S158).

According to this aspect, in some embodiments, the method includes determining a spatial filter for each of at least two unified TCI states. In some embodiments, the method includes associating at least a first CORESET to a first common beam and associate at least a second CORESET to a second common beam. In some embodiments, the method includes associating a CORESET with a common beam based at least in part on an ID of the CORESET. In some embodiments, a CORESET with an even numbered ID is associated with a first common beam and a CORESET with an odd numbered ID is associated with a second common beam. In some embodiments, CORESETs in a first set of CORESETs are associated with common beams in a particular order.

Having described the general process flow of arrangements of the disclosure and having provided examples of hardware and software arrangements for implementing the processes and functions of the disclosure, the sections below provide details and examples of arrangements for common spatial filter indications for control resource sets (CORSETs) in multiple transmission point (TRP) systems.

As used herein, reference to the transmission configuration indicator (TCI) states may refer to either a “DL TCI state” or an “UL TCI state.” Also, the “DL TCI state” and/or “UL TCI state” may be referred to as a “Joint DL/UL TCI state”.

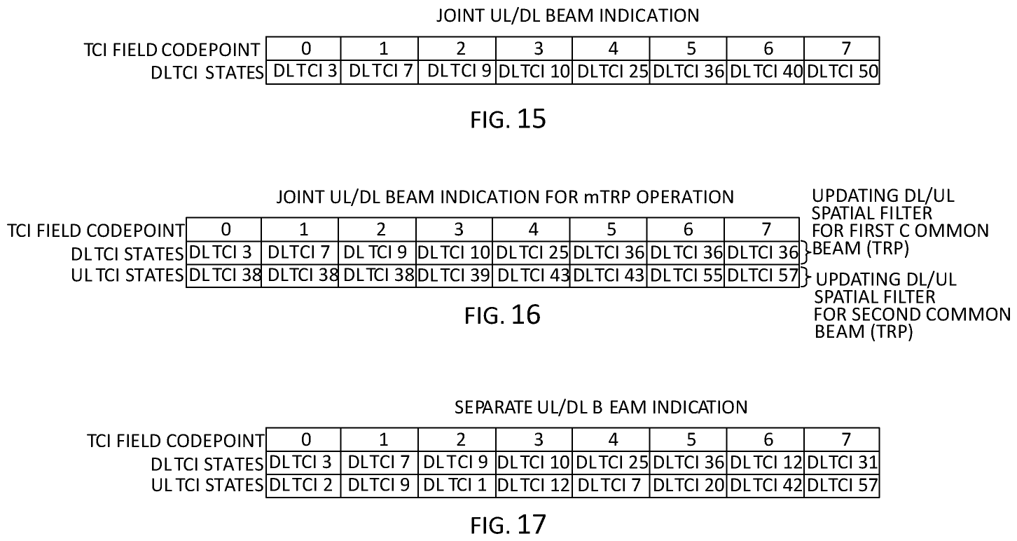

FIG. 15 illustrates a schematic example where a list of activated DL TCI states are mapped to a set of TCI field codepoints in a DCI for Joint DL/UL TCI update for single-TRP based operation. The mapping of DL TCI states to codepoints in the TCI field may be done by MAC CE. In this case, a codepoint of the TCI field in DCI may be used to update a DL TCI state, which may be used by the WD 22 to determine TX/RX spatial filter for both DL and UL signals/channels. For example, in case codepoint 2 is indicated to the WD 22, the WD 22 may update its TX/RX spatial filters based on DL TCI state 9 for both DL and UL signals/channels.

FIG. 16 illustrates a schematic example where a list of activated DL TCI state pairs are mapped to a set of TCI field codepoints in a DCI for Joint DL/UL TCI update for multi-TRP based operation. In this case, a single TCI field codepoint in DCI may be used to update two DL TCI states, which may be used to determine two TX/RX spatial filters for both DL and UL signals/channels (e.g., one spatial filter per TRP). For example, in case a DCI with TCI field codepoint 2 is indicated to the WD 22, the WD 22 may update one TX/RX spatial filter based on DL TCI state 9 for both DL and UL signals/channels associated to a first TRP, and one TX/RX spatial filter based on DL TCI state 38 for both DL and UL signals/channels associated to a second TRP.

It may be that some TCI field codepoints are associated with two DL TCI states, and some TCI field codepoints are associated with a single DL TCI state. In this case, it may be assumed that an indication of a TCI state codepoint associated with a single DL TCI state, indicates to the WD 22 to update the TX/RX spatial filter for only one of the TRPs (while maintaining the current TX/RX spatial filter for the other TRP). Alternatively, a single TCI state associated with a TCI codepoint may also be part of a TCI state pair associated with another TCI codepoint. Activating a single TCI state for single TRP transmission may also activate either one or both TCI states in a TCI state pair associated with another TCI codepoint, in some embodiments. An example is shown in Table 1, where each of codepoints “0” and “1” is associated with a pair of TCI states, while each of codepoints “2” to “5” is associated with a single TCI state, which is one of a TCI state pair associated with codepoint “0” or “1”. TCI states A and B may be activated by either codepoint “0” or codepoints “2” and “3”.

TABLE 1

| | TCI codepoint | | | | | |
|---|---|---|---|---|---|---|
| | 0 | 1 | 2 | 3 | 4 | 5 |
| TCI | TCI | TCI | TCI | TCI | TCI | TCI |
| state(s) | state A | state C | state A | state B | state C | state D |
| | TCI | TCI | | | | |
| | state B | state D | | | | |

FIG. 17 illustrates a schematic example of how a list of activated DL/UL TCI states and their association to TCI field codepoints in DCI may look for separate DL/UL TCI for single-TRP operation, in some embodiments. Here, each TCI field codepoint in DCI is associated with one DL TCI state and one UL TCI state. When a WD 22 is indicated with a certain TCI field codepoint which is mapped to one DL TCI state and one UL TCI state, the WD 22 may apply one DL TCI state and one UL TCI state, in some embodiments.

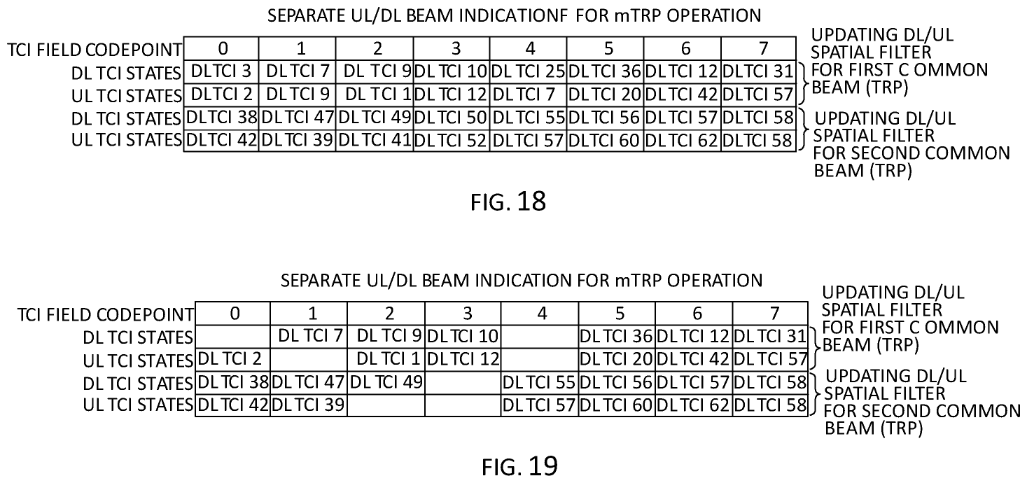

FIG. 18 illustrates a schematic example of how a list of activated DL/UL TCI states and their association to TCI field codepoints in DCI may look for separate DL/UL TCI for multi-TRP operation, in some embodiments. Here, each TCI field codepoint in DCI may be associated with two DL TCI states and two UL TCI states. In this case, a single TCI field codepoint in DCI may be used to update two DL TCI states and two UL TCI states, which may be used to determine two RX spatial filters for DL signals/channels (e.g., one spatial filter per TRP) and two TX spatial filters for UL signals/channels. For example, in case a DCI with TCI field codepoint 2 is indicated to the WD 22, the WD 22 may update: one RX spatial filter based on DL TCI state 9 for DL signals/channels from a first TRP; one RX spatial filter based on DL TCI state 47 for DL signals/channels from a second TRP; one TX spatial filter based on UL TCI state 9 for UL signals/channels from a first TRP; and one TX spatial filter based on UL TCI state 39 for UL signals/channels from a second TRP.

It may be that some TCI field codepoints are associated with zero, one or two DL TCI states and/or zero, one or two UL TCI states. In this case, it may be assumed that an indication of a TCI state codepoint that is associated with a single DL and/or single UL TCI state, indicates to the WD 22 to update the TX and/or RX spatial filter for only one of the TRPs (while maintaining the current TX and/or RX spatial filter for the other TRP). If zero DL TCI states are associated with an indicated TCI field codepoint, the WD 22 may not update its RX spatial filter(s) (only the TX spatial filer(s) based on the associated UL TCI state(s)). In a similar way, if zero UL TCI states are associated with an indicted TCI field codepoint, the WD 22 may not update its TX spatial filter(s) (only the RX spatial filters based on the associated DL TCI state(s)).

FIG. 19 is an example of activated TCI states and their association to TCI field codepoints in DCI for separate DL/UL TCI operation for multi TRP operation, where some TCI field codepoints are associated with zero, one or two DL TCI states and zero, one or two UL TCI states.

In some embodiments, a TRP may be either a network node 16, a radio head, a spatial relation, or a Transmission Configuration Indicator (TCI) state. A TRP may be represented by a TCI state in some embodiments. In some embodiments, a TRP may use multiple TCI states. In some embodiments, a TRP may be a part of the network node 16 transmitting and receiving radio signals to/from a WD 22 according to physical layer properties and parameters inherent to that element. In some embodiments, in Multiple Transmit/Receive Point (multi-TRP) operation, a serving cell may schedule WD 22 from two TRPs, providing better PDSCH coverage, reliability and/or data rates. In some embodiments, there are two different operation modes for multi-TRP: single-DCI and multi-DCI. For both modes, control of uplink and downlink operation may be performed by both physical layer and by MAC, in some embodiments. In single-DCI mode, the WD 22 may be scheduled by the same DCI for both TRPs and in multi-DCI mode, the WD 22 may be scheduled by independent DCIs from each TRP.

Some embodiments may fall within one of the following groups of embodiments:
Embodiments using explicit indication of the association between a CORESET and a common beam; and
Embodiments using implicit indication of the association between a CORESET and a common beam.

### Embodiments Using Explicit Indication of the Association Between a CORESET and a Common Beam (Applied DL TCI State for the Unified TCI State Framework)

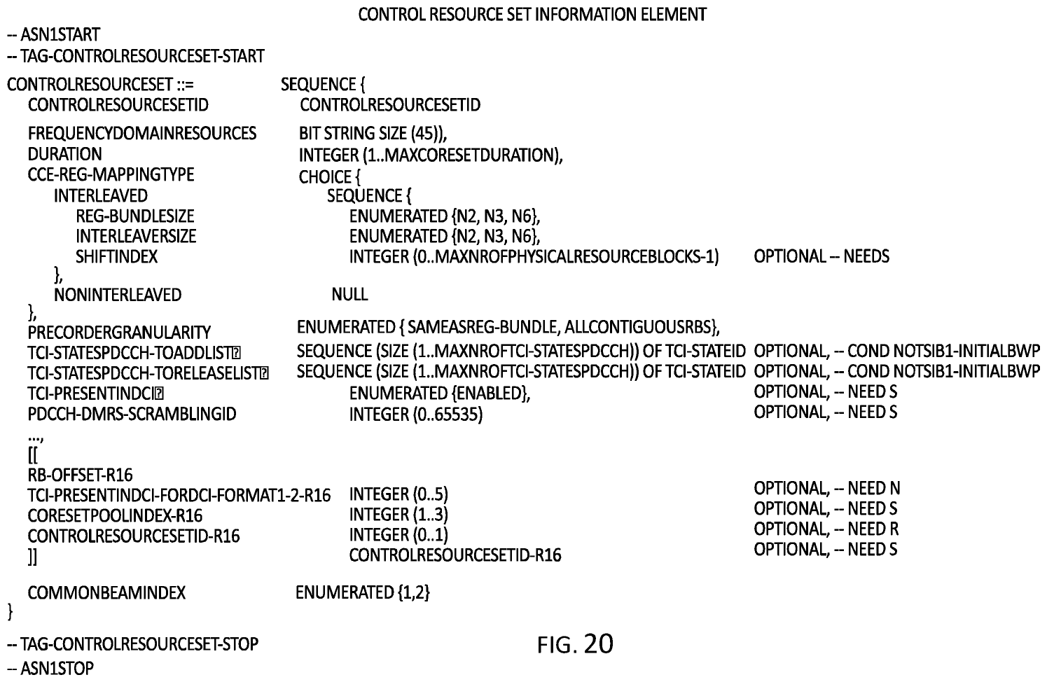

In some embodiments, a parameter referred to herein as “CommonBeamIndex” is introduced. The parameter may be used to associate a CORESET to one of multiple Joint DL/UL TCI states (or DL TCI states) activated by a DCI for DL channels for sDCI based multi-TRP operation. In some embodiments, a CommonBeamIndex is explicitly configured in ControlResourceSet information element (IE) as defined in the 3GPP TS 38.331. One example of this information element is shown in FIG. 20, where the CORESET is configured with either a first or second common TCI state. In some embodiments, if the parameter “CommonBeamIndexes” is not configured for a CORESET, then the CORESET may follow one of the “CommonBeamIndexes” by default. In some cases, the default “CommonBeamIndexes” may be the one with lowest ID (“CommonBeamIndex1” for example).

For a single frequency network (SFN) based PDCCH transmission in a CORESET where a PDSCH is transmitted from two TRPs in the same time frequency resource, the CORESET may be associated with two separate TCI states, one for each TRP. To indicate this, an additional CommonBeamIndex value may be used, for example, the value ‘0’ or value ‘3’ (in addition to value ‘1’ and ‘2’ as used in the example above). The additional CommonBeamIndex value may then be used to indicate that the WD 22 should determine two RX spatial filters when receiving PDCCH in that CORESET. Among the determined two RX spatial filters, a first RX spatial filter may be determined based on a first applied DL TCI state (or joint DL/UL TCI state) associated with a first common beam, and a second RX spatial filter may be determined based on a second applied DL TCI state (or joint DL/UL TCI state) associated with a second common beam.

Note that rather than “CommonBeamIndex”, a different name may be used in the 3GPP specification to divide the CORESETs configured to a WD 22 into two or more groups, each associated to a first, a second, or both the first and second activated common beams. The first and second common beams may be indicated by the first and second DL TCI states (or joint DL/UL TCI states), respectively, indicated by a TCI codepoint in a DCI.

In some embodiments, the association between joint DL/UL TCI state or DL TCI state and ‘CommonBeamIndex’ may be provided in the MAC CE message that activates the joint DL/UL TCI state or DL TCI state. For instance, for each joint DL/UL TCI state or DL TCI state activated in the MAC CE, a corresponding ‘CommonBeamIndex’ field may be included in the MAC CE.

In some embodiments, CORESETs may be grouped into two groups via grouping the CORESET IDs (i.e., controlResourceSetId's) as follows:
CORESET Group 1: {CORESET ID 1, CORESET ID 2, CORESET ID 4}
CORESET Group 2: {CORESET ID 3, CORESET ID 5}

The above two groups may be configured as two lists via higher layer configuration (e.g., via radio resource control (RRC) configuration) to the WD 22. In another alternative, the grouping of CORESET IDs may be indicated to the WD 22 via a MAC CE. For instance, using the above example, the following may be provided in the MAC CE:
CORESET ID 1, CORESET ID 2, and CORESET ID 4 are indicated in MAC CE fields within the MAC CE along with their associated group ID (e.g., group 1) which may be indicated by one or more fields within the MAC CE; and/or
CORESET ID 3, and CORESET ID 5 are indicated in MAC CE fields within the MAC CE along with their associated group ID (e.g., group 2) which may be indicated by one or more fields within the MAC CE.

In the above examples, CORESET Group 1 is associated with a first common beam (i.e., first applied DL TCI state (or joint DL/UL TCI state) using the unified TCI state framework). CORESET Group 2 is associated with a second common beam (i.e., second applied DL TCI state (or joint DL/UL TCI state) using the unified TCI state framework).

### Embodiments Using Implicit Indication of the Association Between a CORESET and a Common Beam (Activated DL TCI State)

In some embodiments, every second CORESET is associated with a first common beam (i.e., first applied DL TCI state (or joint DL/UL TCI state) using the unified TCI state framework), and every other second CORESET is associated with a second common beam (i.e., second applied DL TCI state (or joint DL/UL TCI state) using the unified TCI state framework), where the CORESETs are ordered according to lowest CORESET ID (as specified in the parameter controlResourceSetId in the 3GPP TS 38.311). For example, assume that a WD 22 is configured with CORESET #0, CORESET #1 and CORESET #2. Then, the first CORESET with lowest CORESET ID (CORESET #0) may be associated with a first common beam, the second CORESET with second lowest CORESET ID (CORESET #1) may be associated with a second common beam, the third CORESET with third lowest CORESET ID (CORESET #2) may be associated with the first common beam, and so on.

In some embodiments, every CORESET with even numbered CORESET ID is associated with a first common beam (i.e., first applied DL TCI state using the unified TCI state framework) and every CORESET with odd numbered CORESET ID is associate with a second common beam (i.e., second applied DL TCI state using the unified TCI state framework). For example, assume that a WD 22 is configured with CORESET #0, CORESET #1 and CORESET #2. Then, since CORESET #0 and CORESET #2 are even numbered, they may be associated to a first common beam, and CORESET #1, may be associated to a second common beam since it is odd numbered.

In case a CORESET is configured (either implicitly or explicitly) to be used for SFN based PDCCH reception, and the WD 22 has two common beams (i.e., two applied DL TCI states (or joint DL/UL TCI states) using the unified TCI state framework), the WD 22 may implicitly assume that it may determine two RX spatial filters when receiving that CORESET: where a first RX spatial filter is determined based on a first applied DL TCI state (or joint DL/UL TCI state) associated with a first common beam; and a second RX spatial filter is determined based on a second applied DL TCI state (or joint DL/UL TCI state) associated with a second common beam (i.e., no explicit indication is needed).

In case of two CORESETs, a first and second CORESETs, are configured to be used for repetition based PDCCH transmission and linked together (either implicitly through for example two search space (SS) sets as considered for 3GPP Rel-17 multi-TRP PDCCH reliability enhancements or explicitly linked together). In this case, the WD 22 may have two common beams (i.e., two applied DL TCI states (or joint DL/UL TCI states) using the unified TCI state framework). The WD 22 may implicitly assume:
that the first CORESET is associated with the first common beam (i.e., the WD 22 determines a RX spatial filter based on the applied DL TCI state (or joint DL/UL TCI state) associated with a first common beam when receiving this PDCCH in this first CORESET); and
that the second CORESET is associated with the second common beam (i.e., the WD 22 determines a RX spatial filter based on the applied DL TCI state (or joint DL/UL TCI state) associated with a second common beam when receiving PDCCH in this second CORESET).

In some embodiments, the first CORESET is the one with a smaller CORESET index and the second CORESET is the one with a larger CORESET index. For example, assume that the WD 22 has two CORESETs with CORESET indices 2 and 4, i.e., CORESET #2 and CORESET #4, linked for PDCCH repetition. Then the first CORESET is CORESET #2 and the second CORESET is CORESET #4. The WD 22 may associate CORESET #2 with a first common beam (since CORESET #2 has lowest CORESET ID) and associate CORESET #4 with a second common beam (since it has higher CORESET ID). Alternatively, for two linked SS sets each associated with a CORESET, the CORESET associated with a SS set with a smaller SS set index may be defined as the first CORESET and the CORESET associated with a SS set with a larger SS set index may be defined as the second CORESET. The first and second CORESETs may be associated with the first and second common beams, respectively. The first and second common beams may be associated with, respectively, the first and second TCI states (DL TCI states or joint DL/UL TCI states) indicated in a codepoint of the TCI field in a DCI

According to one aspect, a network node 16 configured to communicate with a wireless device (WD) 22 is provided. The network node 16 includes a radio interface 62 and/or processing circuitry 68 configured to: indicate to the WD 22 at least one transmission configuration indicator, TCI, state, each of the at least one TCI state having quasi-co-located, QCL, information related to at least one reference signal; and activate a TCI state for a physical downlink control channel, PDCCH and at least one TCI state for a physical downlink shared channel, PDSCH.

According to this aspect, in some embodiments, the processing circuitry 68 is further configured to map a set of TCI states to a set of TCI codepoints in a downlink control information, DCI, message for joint downlink/uplink TCI update for single transmission reception point, TRP, operation. In some embodiments, each codepoint in the DCI message is associated with one downlink TCI state and one uplink TCI state. In some embodiments, the processing circuitry 68 is further configured to map a set of TCI states to a set of TCI codepoints in a downlink control information, DCI, message for joint downlink/uplink TCI update for multi-transmission reception point, TRP, operation. In some embodiments, each codepoint in the DCI message is associated with more than one downlink TCI state and/or more than one uplink TCI state.

According to another aspect, a method implemented in a network node 16 configured to communicate with a wireless device, WD 22, is provided. The method includes: indicating to the WD 22 at least one transmission configuration indicator, TCI, state, each of the at least one TCI state having quasi-co-located, QCL, information related to at least one reference signal; and activating a TCI state for a physical downlink control channel, PDCCH and at least one TCI state for a physical downlink shared channel, PDSCH.

According to this aspect, in some embodiments, the method also includes mapping a set of TCI states to a set of TCI codepoints in a downlink control information, DCI, message for joint downlink/uplink TCI update for single transmission reception point, TRP, operation. In some embodiments, each codepoint in the DCI message is associated with one downlink TCI state and one uplink TCI state. In some embodiments, the method also includes mapping a set of TCI states to a set of TCI codepoints in a downlink control information, DCI, message for joint downlink/uplink TCI update for multi-transmission reception point, TRP, operation. In some embodiments, each codepoint in the DCI message is associated with more than one downlink TCI state and/or more than one uplink TCI state.

According to yet another aspect, a WD 22 is configured to communicate with a network node 16. The WD 22 includes a radio interface 82 and/or processing circuitry 84 configured to: receive an indication of at least one transmission configuration indicator, TCI, state, each of the at least one TCI state having quasi-co-located, QCL, information related to at least one reference signal; and update spatial filters based on an indicated TCI state.

According to this aspect, in some embodiments, updating spatial filters includes updating a first spatial filter based on a first TCI state and updating a second spatial filter based on a second TCI state. In some embodiments, the first TCI state is a downlink TCI state and the second TCI state is an uplink TCI state.

According to another aspect, a method implemented in a wireless device (WD) 22. The method includes receiving an indication of at least one transmission configuration indicator, TCI, state, each of the at least one TCI state having quasi-co-located, QCL, information related to at least one reference signal; and updating spatial filters based on an indicated TCI state.

According to this aspect, in some embodiments, updating transmit and received filters includes updating a first spatial filter based on a first TCI state and updating a second spatial filter based on a second TCI state. In some embodiments, the first TCI state is a downlink TCI state and the second TCI state is an uplink TCI state.

Some embodiments may include one or more of the following:

Embodiment A1. A network node configured to communicate with a wireless device (WD), the network node configured to, and/or comprising a radio interface and/or comprising processing circuitry configured to:
indicate to the WD at least one transmission configuration indicator, TCI, state, each of the at least one TCI state having quasi-co-located, QCL, information related to at least one reference signal; and
activate a TCI state for a physical downlink control channel, PDCCH and at least one TCI state for a physical downlink shared channel, PDSCH.

Embodiment A2. The network node of Embodiment A1, wherein the processing circuitry is further configured to map a set of TCI states to a set of TCI codepoints in a downlink control information, DCI, message for joint downlink/uplink TCI update for single transmission reception point, TRP, operation.

Embodiment A3. The network node of Embodiment A2, wherein each codepoint in the DCI message is associated with one downlink TCI state and one uplink TCI state.

Embodiment A4. The network node of Embodiment A1, wherein the processing circuitry is further configured to map a set of TCI states to a set of TCI codepoints in a downlink control information, DCI, message for joint downlink/uplink TCI update for multi-transmission reception point, TRP, operation.

Embodiment A5. The network node of Embodiment A4, wherein each codepoint in the DCI message is associated with more than one downlink TCI state and/or more than one uplink TCI state.

Embodiment B1. A method implemented in a network node configured to communicate with a wireless device, WD, the method comprising:
indicating to the WD at least one transmission configuration indicator, TCI, state, each of the at least one TCI state having quasi-co-located, QCL, information related to at least one reference signal; and
activating a TCI state for a physical downlink control channel, PDCCH and at least one TCI state for a physical downlink shared channel, PDSCH.

Embodiment B2. The method of Embodiment B1, further comprising mapping a set of TCI states to a set of TCI codepoints in a downlink control information, DCI, message for joint downlink/uplink TCI update for single transmission reception point, TRP, operation.

Embodiment B3. The method of Embodiment B2, wherein each codepoint in the DCI message is associated with one downlink TCI state and one uplink TCI state.

Embodiment B4. The method of Embodiment B1, further comprising mapping a set of TCI states to a set of TCI codepoints in a downlink control information, DCI, message for joint downlink/uplink TCI update for multi-transmission reception point, TRP, operation.

Embodiment B5. The method of Embodiment B4, wherein each codepoint in the DCI message is associated with more than one downlink TCI state and/or more than one uplink TCI state.

Embodiment C1. A wireless device (WD) configured to communicate with a network node, the WD configured to, and/or comprising a radio interface and/or processing circuitry configured to:
receive an indication of at least one transmission configuration indicator, TCI, state, each of the at least one TCI state having quasi-co-located, QCL, information related to at least one reference signal; and
update spatial filters based on an indicated TCI state.

Embodiment C2. The WD of Embodiment C1, wherein updating spatial filters includes updating a first spatial filter based on a first TCI state and updating a second spatial filter based on a second TCI state.

Embodiment C3. The WD of Embodiment C2, wherein the first TCI state is a downlink TCI state and the second TCI state is an uplink TCI state.

Embodiment D1. A method implemented in a wireless device (WD), the method comprising:
receiving an indication of at least one transmission configuration indicator, TCI, state, each of the at least one TCI state having quasi-co-located, QCL, information related to at least one reference signal; and
updating spatial filters based on an indicated TCI state.

Embodiment D2. The method of Embodiment D1, wherein updating spatial filters includes updating a first spatial filter based on a first TCI state and updating a second spatial filter based on a second TCI state.

Embodiment D3. The method of Embodiment D2, wherein the first TCI state is a downlink TCI state and the second TCI state is an uplink TCI state.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a wireless device, WD (22), the network node (16) comprising:
processing circuitry (68) configured to:
activate and indicate a first and a second unified transmission configuration indicator, TCI, state of a plurality of unified TCI states configured for the WD (22), the first and second unified TCI states being used for at least one of downlink reception and uplink transmission for a plurality of physical channels by the WD (22); and
associate a control resource set, CORESET, to one of the first unified TCI state and the second unified TCI state, by at least one of:
configuring a pointer for the CORESET, the pointer pointing to at least one of the first unified TCI state and the second unified TCI state;
configuring a CORESET group identifier for the CORESET, the CORESET group identifier identifying a CORESET group to which the CORESET belongs; and
according to predefined rules known to the WD (22).

2. The network node (16) of claim 1, wherein the first and the second unified TCI states are activated by a first medium access control, MAC, control element, CE, command, among a plurality of configured unified TCI states.

3. The network node (16) of any of claims 1 and 2, wherein the first and the second unified TCI states are indicated by a downlink control information, DCI, format, among a plurality of activated unified TCI states.

4. The network node (16) of any of claims 1-3, wherein associating the CORESET to at least one of the first unified TCI state and the second unified TCI state includes receiving one or more downlink physical downlink control channels, PDCCHs, in the CORESET according to the at least one of the first unified TCI state and the second unified TCI state.

5. The network node (16) of any of claims 1-4, further comprising a radio interface (62) in communication with the processing circuitry (68) and configured to transmit to the WD (22) in at least one of the first medium access control, MAC, control element, CE command, and the DCI, the pointer and the group identifier.

6. The network node (16) of any of claims 1-5, wherein the first and second unified TCI states contain information of a first and second common beam, respectively.

7. The network node (16) of claim 6, wherein the first and second common beams are associated to a first and a second transmission and reception point, TRP, respectively.

8. The network node (16) of claim 1-7, wherein the first and second unified TCI states contain information of a first and second spatial receive filter, respectively.

9. The network node (16) of any of claims 1-3, wherein, when the pointer is not configured for the CORESET, then the CORESET is associated with one of the first and second unified TCI states by default.

10. The network node (16) of any of claims 2-9, wherein the pointer is transmitted in a second medium access control, MAC, control element, CE command.

11. The network node (16) of any of claims 2-10, wherein the group identifier is transmitted in the second MAC CE command.

12. The network node (16) of any of claims 10 and 11, wherein the second MAC CE command is the same as the first MAC CE command.

13. The network node (16) of any of claims 1-12, wherein the pointer is transmitted in a Radio Resource Control (RRC) message.

14. The network node (16) of any of claims 1-13, wherein the group identifier is transmitted in a radio resource control, RRC, message.

15. The network node (16) of any of claims 1-14, wherein each of a first group of CORESETs is associated with the first unified TCI state and each of a second group of CORESETs is associated with the second unified TCI state.

16. The network node (16) of any of claims 1-15, wherein one of the predefined rules is that every second CORESET is associated with the first unified TCI state and every other second CORESET is associated with the second unified TCI state.

17. The network node (16) of any of claims 1-16, wherein a CORESET with an even numbered ID is associated with the first unified TCI state and a CORESET with an odd numbered ID is associated with the second unified TCI state.

18. The network node (16) of any of claims 16 and 17, wherein each CORESET in the first group is associated with one of the first and second unified TCI states in a particular order known to the WD (22).

19. A method in a network node (16) configured to communicate with a wireless device, WD (22), the method comprising:
activating and indicating (S142) a first and a second unified transmission configuration indicator, TCI, state of a plurality of unified TCI states configured for the WD (22), the first and second unified TCI states being used for at least one of downlink reception and uplink transmission for a plurality of physical channels by the WD (22); and
associating (S144) a control resource set, CORESET, to one of the first unified TCI state and the second unified TCI state, by at least one of:
configuring (S146) a pointer for the CORESET, the pointer pointing to at least one of the first unified TCI state and the second unified TCI state;
configuring (S148) a CORESET group identifier for the CORESET, the CORESET group identifier identifying a CORESET group to which the CORESET belongs; and
according (S150) to predefined rules known to the WD (22).

20. The method of claim 19, wherein the first and the second unified TCI states are activated by a first medium access control, MAC, control element, CE, command, among a plurality of configured unified TCI states.

21. The method of any of claims 19 and 20, wherein the first and the second unified TCI states are indicated by a downlink control information, DCI, format, among a plurality of activated unified TCI states.

22. The method of any of claims 19-21, wherein associating the CORESET to at least one of the first unified TCI state and the second unified TCI state includes receiving one or more downlink physical downlink control channels, PDCCHs, in the CORESET according to the at least one of the first unified TCI state and the second unified TCI state.

23. The method of any of claims 19-22, further comprising transmitting to the WD (22) in at least one of the first medium access control, MAC, control element, CE command, and the DCI, the pointer and the group identifier.

24. The method of any of claims 19-23, wherein the first and second unified TCI states contain information of a first and second common beam, respectively.

25. The method of claim 24, wherein the first and second common beams are associated to a first and a second transmission and reception point, TRP, respectively.

26. The method of claim 19-25, wherein the first and second unified TCI states contain information of a first and second spatial receive filter, respectively.

27. The method of any of claims 19-26, wherein, when the pointer is not configured for the CORESET, then the CORESET is associated with one of the first and second unified TCI states by default.

28. The method of any of claims 20-27, wherein the pointer is transmitted in a second medium access control, MAC, control element, CE command.

29. The method of any of claims 20-28, wherein the group identifier is transmitted in a second MAC CE command.

30. The method of any of claims 28 and 29, wherein the second MAC CE command is the same as the first MAC CE command.

31. The method of any of claims 19-20, wherein the pointer is transmitted in a Radio Resource Control (RRC) message.

32. The method of any of claims 19-31, wherein the group identifier is transmitted in a radio resource control, RRC, message.

33. The method of any of claims 19-32, wherein each of a first group of CORESETs is associated with the first unified TCI state and each of a second group of CORESETs is associated with the second unified TCI state.

34. The method of any of claims 19-33, wherein one of the predefined rules is that every second CORESET is associated with the first unified TCI state and every other second CORESET is associated with the second unified TCI state.

35. The method of any of claims 19-34, wherein a CORESET with an even numbered ID is associated with the first unified TCI state and a CORESET with an odd numbered ID is associated with the second unified TCI state.

36. The method of any of claims 34 and 35, wherein each CORESET in the first group is associated with one of the first and the second unified TCI states in a particular order known to the WD (22).

37. A wireless device, WD (22), configured to communicate with a network node (16), the WD (22) comprising:
a radio interface (82) configured to:
receive an indication of a first and a second unified transmission configuration indication, TCI, state of a plurality of unified TCI states, the first and second unified TCI states being associated with at least one of downlink reception and uplink transmission for a plurality of physical channels;
receive a pointer to a control resource set, CORESET, the pointer pointing to at least one of the first and second unified TCI states; and
receive a CORESET group identifier identifying a CORESET group to which the CORESET belongs; and
processing circuitry (84) in communication with the radio interface (82) and configured to associate the CORESET to one of the first and second unified TCI states.

38. The WD (22) of claim 25, wherein the processing circuitry (84) is further configured to determine a spatial filter for each of at least two unified TCI states.

39. The WD (22) of any of claims 25 and 26, wherein the processing circuitry (84) is further configured to associate at least a first CORESET to a first common beam and associate at least a second CORESET to a second common beam.

40. The WD (22) of any of claims 25-27, wherein the processing circuitry (84) is further configured to associate a CORESET with a common beam based at least in part on an ID of the CORESET.

41. The WD (22) of any claim 28, wherein a CORESET with an even numbered ID is associated with a first common beam and a CORESET with an odd numbered ID is associated with a second common beam.

42. The WD (22) of any claims 25-28, wherein CORESETs in a first set of CORESETs are associated with common beams in a particular order.

43. A method in a wireless device, WD (22), configured to communicate with a network node (16), the method comprising:
receiving (S152) an indication of a first and a second unified transmission configuration indication, TCI, state of a plurality of unified TCI states, the first and second unified TCI states being associated with at least one of downlink reception and uplink transmission for a plurality of physical channels;
receiving (S154) a pointer to a control resource set, CORESET, the pointer pointing to at least one of the first and second unified TCI states; and
receiving (S156) a CORESET group identifier identifying a CORESET group to which the CORESET belongs;
associating (S158) the CORESET to one of the first and second unified TCI states.

44. The method of claim 31, further comprising determining a spatial filter for each of at least two unified TCI states.

45. The method of any of claims 31 and 32, further comprising associating at least a first CORESET to a first common beam and associate at least a second CORESET to a second common beam.

46. The method of any of claims 25-33, further comprising associating a CORESET with a common beam based at least in part on an ID of the CORESET.

47. The method of any claim 34, wherein a CORESET with an even numbered ID is associated with a first common beam and a CORESET with an odd numbered ID is associated with a second common beam.

48. The method of any claims 31-34, wherein CORESETs in a first set of CORESETs are associated with common beams in a particular order.
